(19) United States
(12) Patent Application Publication
(10) Pub. No.: US 2020/0373773 A1
(43) Pub. Date: Nov. 26, 2020

(54) CHARGING DEVICE FOR AN ELECTRONIC CIGARETTE AND USB CHARGED DEVICES

(71) Applicant: PODBANK, LLC, Sanford, FL (US)

(72) Inventors: Charles Harris, Graham, NC (US); Matthew R. Kleizo, Longwood, FL (US)

(21) Appl. No.: 16/529,874

(22) Filed: Aug. 2, 2019

Related U.S. Application Data
(63) Continuation-in-part of application No. 29/692,080, filed on May 22, 2019.

(51) Int. Cl. H02J 7/00; A24F 47/00

(52) U.S. Cl. CPC H02J 7/0052; H02J 7/0045; A24F 47/008

(57) ABSTRACT

A charging device includes a portable housing carrying a battery. A charging circuit and at least one USB connector port are carried within the front end of the portable housing and connected to the charging circuit. A cigarette retainer on the top surface of the portable housing receives and retains an electronic cigarette in a charging position. At least one charging contact is connected to the charging circuit and positioned to engage a battery contact on the electronic cigarette when the electronic cigarette is in the charging position to charge the electronic cigarette.

### PRIORITY APPLICATION(S)

This is a continuation-in-part application of U.S. patent application Ser. No. 29/692,080 filed May 22, 2019, the disclosure which is hereby incorporated by reference in its entirety.

### FIELD OF THE INVENTION

The present invention relates to the field of charging devices, and more particularly, this invention relates to a charging device for an electronic cigarette and USB charged devices.

### BACKGROUND OF THE INVENTION

Electronic cigarettes usually have a battery contained within a housing to form a battery-powered vaporizer, also termed an ecig, vape device, or by other device names. These devices simulate the feel of smoking, but without the dangerous use of tobacco. Instead of inhaling cigarette smoke, the user inhales an aerosol, in a process commonly termed “vaping.” The aerosol is a vapor that is released by a heating element within the vape device that atomizes a liquid solution, sometimes called a vape solution, juice, or eJuice by those in the industry. The electronic cigarette may be activated when the user inhales on the vape device, such as when taking a puff, or by pressing a button on the vape device.

Some vaporizers as electronic cigarettes are cylindrical and look similar to a traditional cigarette. There may be marketing advantages in mimicking the look, dimension, and feel of traditional cigarettes. However, that cylindrical shape is not always optimal, and many electronic cigarettes are rectangular configured, allowing in some cases a greater volume for holding a battery and vaporizable material. The rectangular shape sometimes makes handling and manufacture of the vape device easier. Some of the rectangular configured vaporizers have a reusable battery in a bottom section as a housing that connects to one or more cartridges, also referred to sometimes as “pods,” containing the consumable vaporizable material. As the user vapes, cartridges are used, removed, and replaced with a fresh cartridge into the device.

One well-known electronic cigarette is manufactured by JUUL Labs, Inc. of San Francisco, Calif. This type of electronic cigarette device includes a larger bottom rectangular section containing a rechargeable battery and temperature regulation system, and a smaller top section containing the vaporizable liquid or eJuice. This e-liquid cartridge is the section that the user inserts into the bottom section of the device. This cartridge is also the mouthpiece, and by inserting, e.g., clicking it into the bottom section of the device, the device becomes operational.

Most electronic cigarettes are rechargeable and each purchased device comes usually with a USB charger that the user inserts into a laptop or charging block. An example is the popular JUUL Labs device. This type of electronic cigarette has no settings and the device senses when the user inhales or takes a “pull” from the mouthpiece and the internal heater heats up to vaporize the liquid inside. The circuit includes a special temperature-regulation circuit to prevent overheating or combustion, and as a result, it is less likely to burn or explode, which has been a problem with some vape devices.

The cartridges containing the vaporizable material as the eJuice are also referred to as “pods” and come in different flavors, such as cool mint or fruit as examples. The pods contain a mix of glyceryl and propylene glycol, benzoic acid, flavorants and some nicotine, which can vary. Some pods may contain as much nicotine as one pack of cigarettes in certain high nicotine containing pods.

The vast majority of users of electronic cigarettes also carry other battery powered portable devices, such as portable telephones, e.g., the iPhone, sometimes a tablet device, e.g., an iPad, and other portable devices that can be charged from separate charging devices provided with each device. Most of the charging devices provided by the manufacturer of these different devices, such as a portable phone or tablet, often require a source of AC power as household current, and may include a USB adapter that plugs into the household outlet. The user's electronic cigarette may require another charging device that plugs into the household outlet via a plug adapter such as a USB connector plug or to the user's laptop or computer. Having many devices could be problematic and require numerous and separate charging devices for each device. Many users may not always have access to an AC power outlet, and thus, require a more portable solution to charge their numerous devices at once, including the ubiquitous cell phone, and for many, their electronic cigarette. Many of these devices can be powered via a USB connector port, while the electronic cigarette, such as a JUUL device, may require a separate device fitted for that particular electronic cigarette.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

A charging device for an electronic cigarette and USB charged devices may include a portable housing having a top, a bottom, sides, a front end, and a rear end. A battery is carried within the housing. A charging circuit is connected to the battery. At least one USB connector port is carried within the portable housing and connected to the charging circuit and configured for charging a USB charged device when connected thereto. A cigarette retainer at the top of the portable housing may be configured to receive and retain an electronic cigarette in a charging position. At least one charging contact may be connected to the charging circuit and positioned at the cigarette retainer and configured to engage a battery contact on the electronic cigarette when in the charging position to charge the electronic circuit.

The cigarette retainer may include a channel member extending longitudinally along the top to the rear end of the portable housing and configured as a channel that receives the electronic cigarette therein. The at least one charging contact may be positioned within the channel adjacent the rear end of the housing. The channel member may include an upper surface and a slot formed in the upper surface that is configured to expose to view an electronic cigarette received within the channel. The channel may be substantially rectangular configured to retain a rectangular configured electronic cigarette therein. A magnet may be at the cigarette retainer to aid in retaining the electronic cigarette in the charging position.

A contact support board may support the at least one charging contact and a lead may be connected to the contact support board and operatively connected to the charging circuit. A circuit board may be supported within the front end of the portable housing and connected to the battery. The charging circuit and at least one USB connector port are mounted on the circuit board. The charging circuit may include an integrated circuit comprising a system control, a Light Emitting Diode (LED) driver circuit, and a USB circuit connected to the at least one USB connector port. The at least one LED may be connected to the LED driver circuit to indicate a charging status of the battery. At least one light channel member may extend from the at least one LED to the top surface of the portable housing. The at least one USB connector port may comprise spaced first and second Type A connector ports, and a Type C connector port positioned between the first and second Type A connector ports. The front end of the portable housing may have an opening configured to receive a respective USB connector that connects to a respective connector port. The portable housing may be rectangular configured and sized to be carried by hand.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is a top isometric view of the charging device showing the top partially broken away and internal components in accordance with a non-limiting example.

FIG. 2 is a top plan view of the charging device of FIG. 1.

FIG. 3 is a bottom plan view of the charging device of FIG. 1.

FIG. 4 is a left side elevation view of the charging device of FIG. 1.

FIG. 5 is a right side elevation view of the charging device of FIG. 1.

FIG. 6 is a front elevation view of the charging device of FIG. 1.

FIG. 7 is a rear elevation view of the charging device of FIG. 1.

FIG. 8 is another top isometric view of the charging device of FIG. 1 showing an electronic cigarette inserted partially within the channel.

FIG. 9 is another top isometric view of the charging device of FIG. 1 and shown charging an electronic cigarette and portable phone.

FIG. 10A is a plan view of the charging device of FIG. 1 showing the retainer cover removed from the charging device.

FIG. 10B is an underside view of the retainer cover of FIG. 10A.

FIG. 11 is a bottom isometric view of the charging device having the bottom cover removed and showing the battery and circuit board.

FIG. 12 is an enlarged, front, isometric view of the charging device similar to that of FIG. 11 and showing the circuit board turned vertically and components mounted on the circuit board.

FIG. 13 is an isometric view of the front end top cover and showing the light channel members.

FIG. 14 is a schematic plan view of the circuit board, lead and contact support board that supports the charging contacts.

FIG. 15 is a block diagram of an example of the integrated circuit used in the charging circuit.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

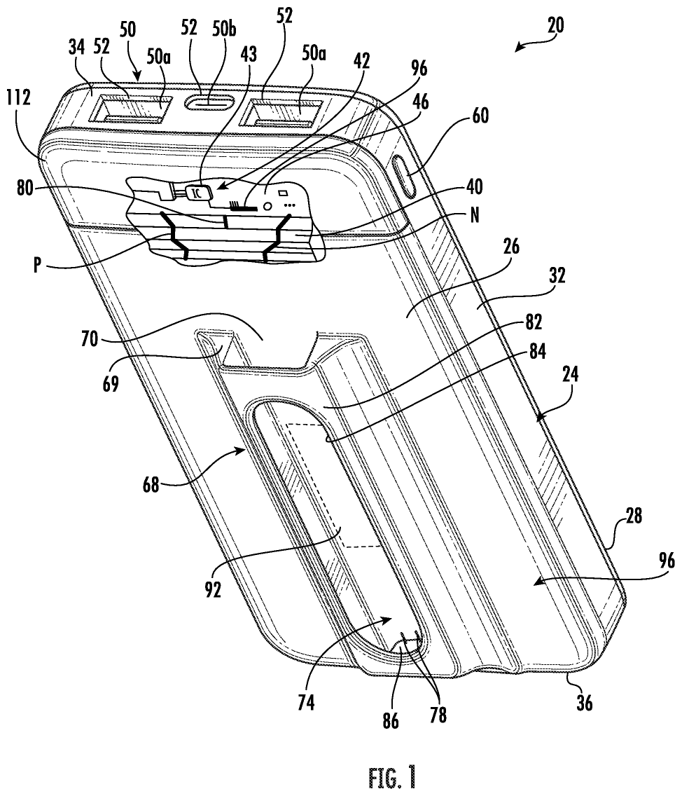

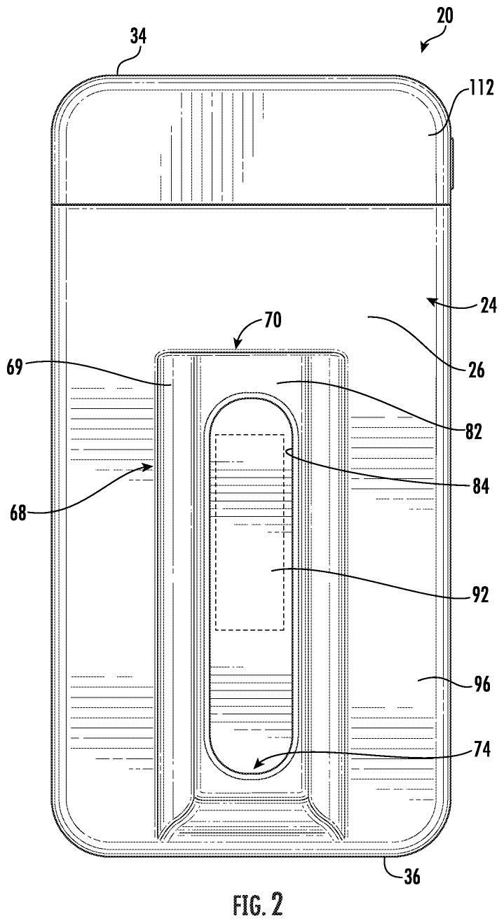

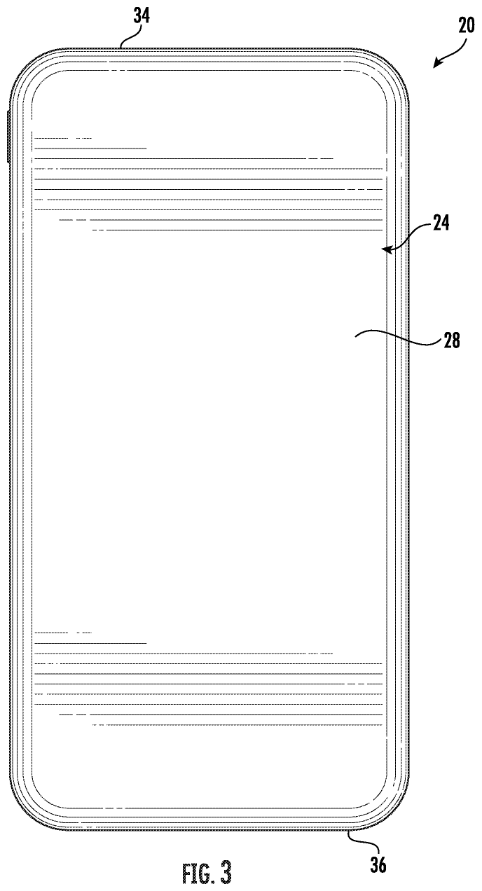

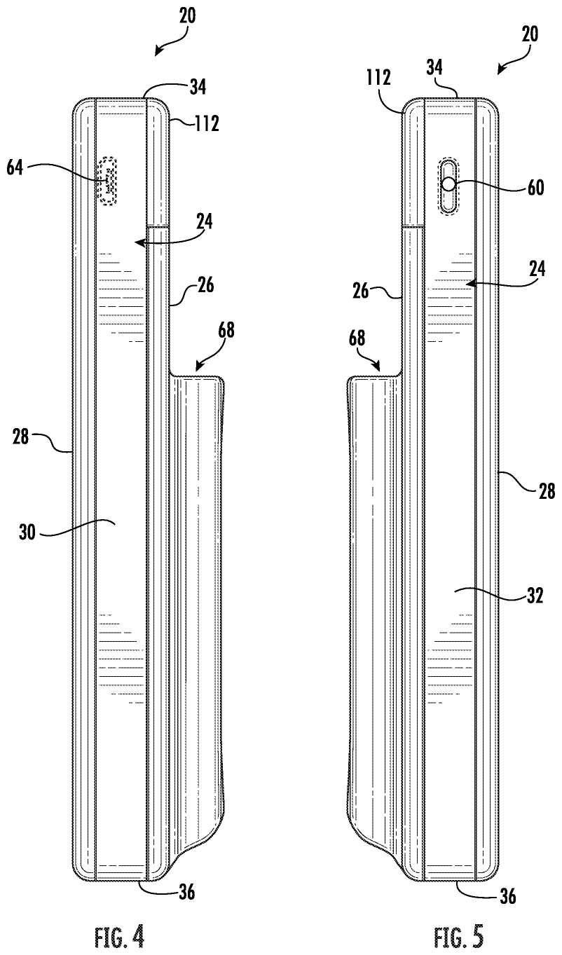

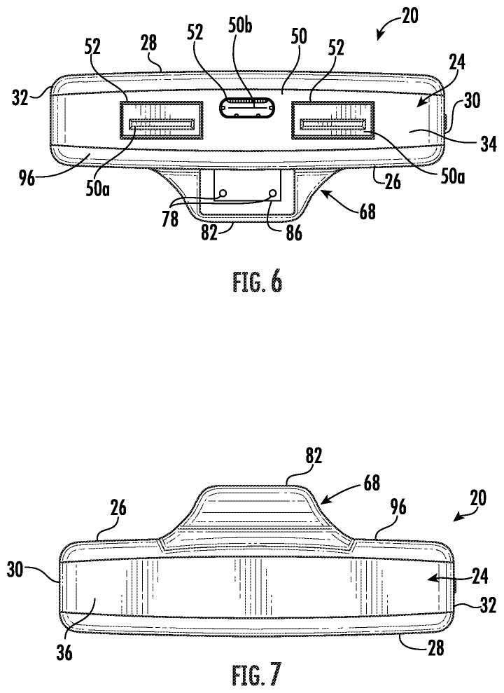

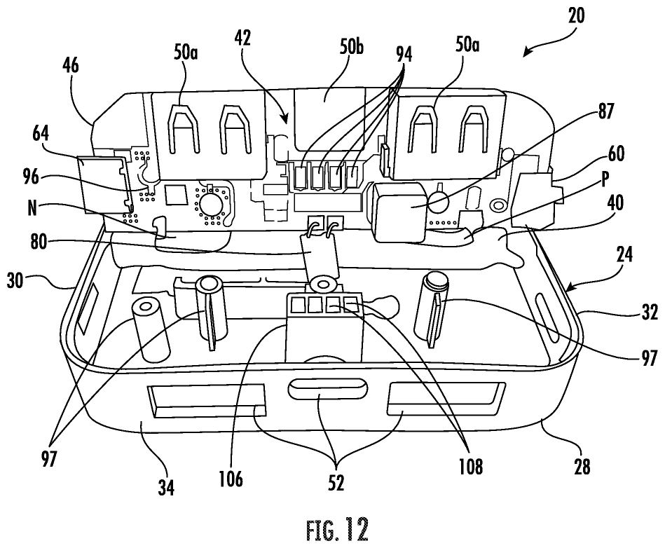

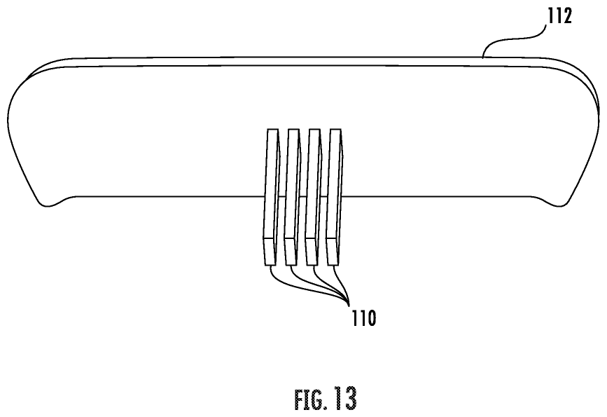

Referring to FIG. 1, there is illustrated generally at 20 the charging device for an electronic cigarette and USB charged devices that also operates as a portable power storage device. The charging device 20 includes a portable housing 24 having a top 26 (FIGS. 1 and 2), bottom 28 (FIG. 3), left and right sides 30,32 (FIGS. 4 and 5), a front end 34 and a rear end 36 (FIGS. 6 and 7). A battery 40 is carried within the portable housing 34 as shown in the cut-away section of FIG. 1, where a portion of the interior of the portable housing is illustrated, and in an example, is a rechargeable battery. A charging circuit 42 is connected to the battery 40, and in this example, includes an integrated circuit 43 mounted on a circuit board 46 at the front end 34 of the portable housing 24. As illustrated generally at 50, at least one USB connector port, and in this example, spaced USB connector ports are carried within the front end 34 of the portable housing 24 and mounted on the circuit board 46 (FIG. 12) and connected to the charging circuit 42.

The USB connector ports 50 are configured for charging USB charged devices when connected thereto. The front end 34 of the portable housing 24 has openings 52 at respective USB connector ports 50 and each are configured to receive a USB connector that connects to a respective USB connector port. In this example, the spaced USB connector ports 50 are spaced first and second Type A connector ports 50a and a Type C connector port 50b that is positioned between the first and second Type A connector ports. The openings 52 in the front end 34 are adjacent the respective USB connector ports 50a, 50b and are configured to receive a respective USB connector that connects to a respective first and second Type A USB connector port and Type C USB connector port.

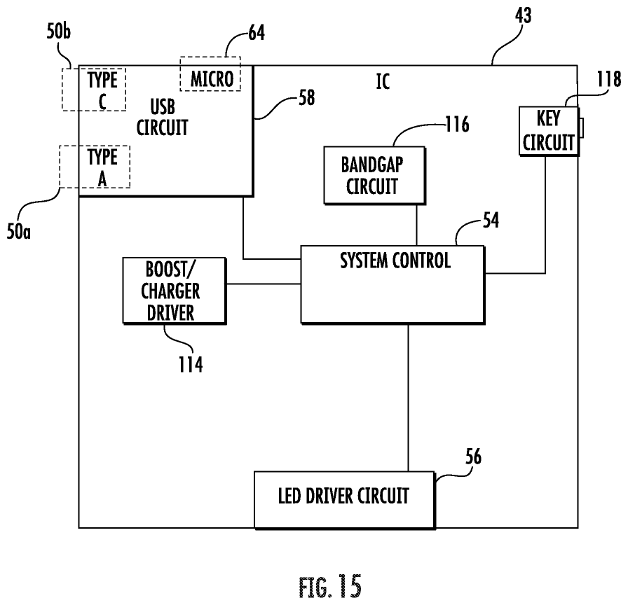

The circuit board 46 may be supported within the front end 34 of the portable housing 24 and connected to the battery 40. The integrated circuit 43 as part of the charging circuit 42 and the spaced USB connector ports 50a, 50b are mounted on the circuit board 46 and positioned adjacent the respective openings 52. In an example, the integrated circuit 43 may include a system control 54, Light Emitting Diode (LED) driver circuit 56, and at least one USB circuit 58 for connecting to the USB connector ports 50a, 50b, as shown in the block diagram of the integrated circuit in FIG. 15, and as will be explained in greater detail below.

The integrated circuit 43 may be mounted on what is termed the bottom side of the circuit board 46 since that bottom side of the circuit board faces the bottom 28 of the portable housing 24. The top side of the circuit board 46 faces the top 26 and has the first and second Type A USB connector ports 50a and Type C USB connector port 50b mounted on the circuit board as best shown in FIG. 12, where the circuit board 46 is turned up 90° vertically to show the top side of the circuit board 46. An on-off switch 60 is connected to the charging circuit 42 and mounted on the circuit board 46 and configured to be depressed by a user (FIGS. 5 and 12). This on-off switch 60 is mounted on the circuit board 46 at the right side 32 of the portable housing 24 and exposed via an opening in the right side of the portable housing so it can be depressed by a user. A micro USB charging port 64 is mounted on the circuit board 46 and connected to the charging circuit 42 and configured to receive a micro USB cable such as for charging the battery 40. The micro USB charging port 64 is mounted on the circuit board 46 at the left side 30 and exposed via an opening in the left side of the portable housing 24 such that a micro USB charging cable can be connected.

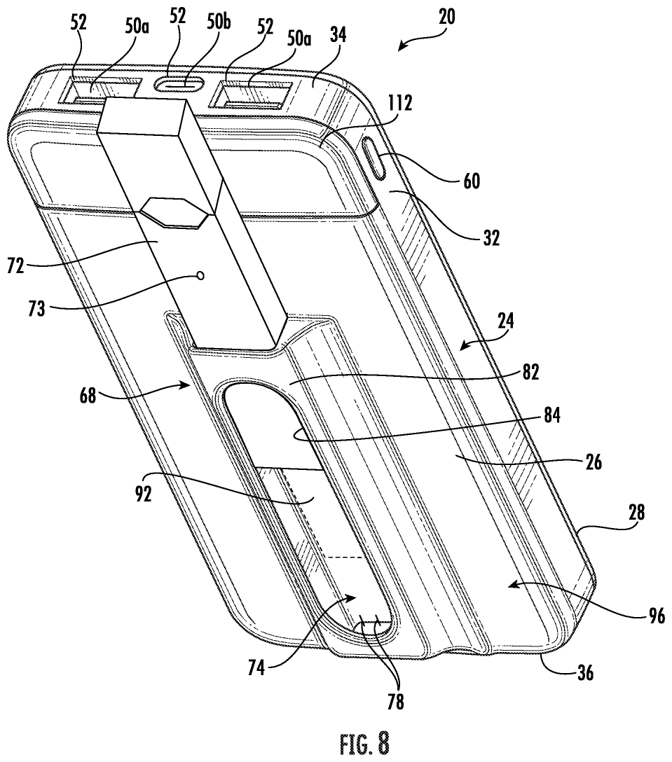

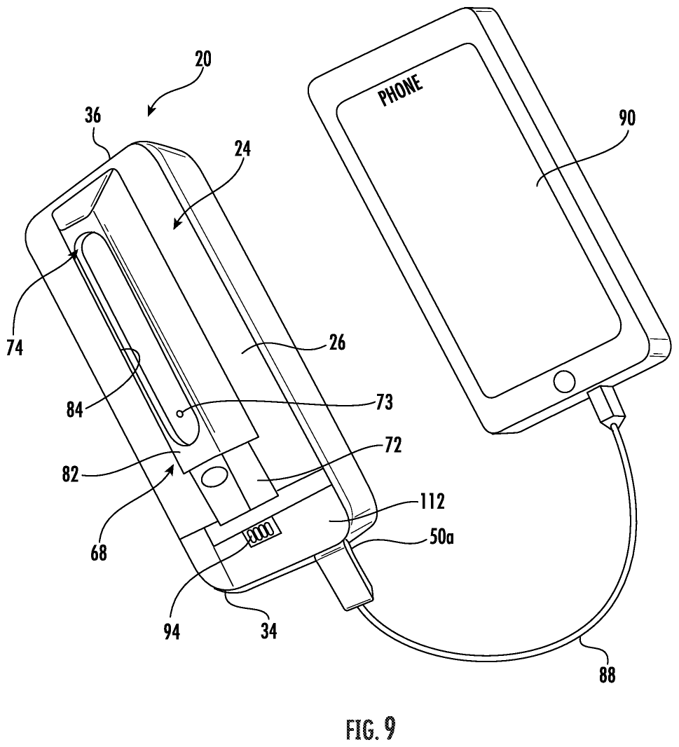

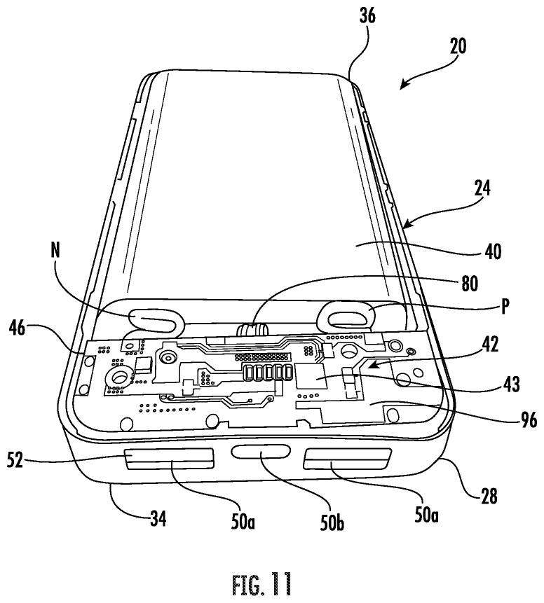

As best shown in FIG. 1, a cigarette retainer 68 is at the top 26 of the portable housing 24 and configured to receive and retain an electronic cigarette for charging and may include a channel member 69 that extends longitudinally on the top 26 of the portable housing 24 to the rear end 36. The channel member 69 is configured as a channel 70 that receives the electronic cigarette 72 therein (FIG. 8), and retains the electronic cigarette 72 in a charging position 74 as shown in FIG. 9, where the electronic cigarette is received within the channel and extends all the way into the channel to the rear end 36. At least one charging contact 78, and as shown in FIG. 1, a pair of charging contacts are connected to the charging circuit 42 via an electrical lead 80, which is connected to the circuit board 46 (FIGS. 11 and 12) and extends through the portable housing 24 to the rear end 36. The charging contacts 78 are positioned within the channel 70 at the end 36 of the portable housing 24. The charging contacts 78 are configured to engage at least one battery contact on the electronic cigarette 72 when the electronic cigarette is inserted completely within the channel 70 to the end 36 and positioned into the charging position 74 to charge the electronic cigarette. The channel member 69 includes an upper surface 82 and a slot 84 is formed in the upper surface and configured to expose for viewing by the user an electronic cigarette 72 received within the channel 70. Thus, the electronic cigarette may be viewed by the user of the charging device 20, and in an example, some electronic cigarettes 72 may include a charge indicator light 73 as shown in FIG. 9 that may indicate whether the electronic cigarette is charging. For example, the slot 84 exposes for view the charge indicator light 73 on the electronic cigarette 72. When the light 73 is blinking, it may indicate the electronic cigarette 72 is still charging, while an unblinking light may indicate the charge is completed. The channel 70 is substantially rectangular configured, in this example, to retain an elongate and rectangular configured electronic cigarette 72 therein, such as an electronic cigarette manufactured by JUUL Labs, Inc. A typical size for this type of electronic cigarette 72 is about 3.7×0.5×0.2 inches, and the channel 70 is dimensioned slightly larger to receive the electronic cigarette with enough clearance so that it can be inserted easily, but without having undue slop and side-to-side movement within the channel.

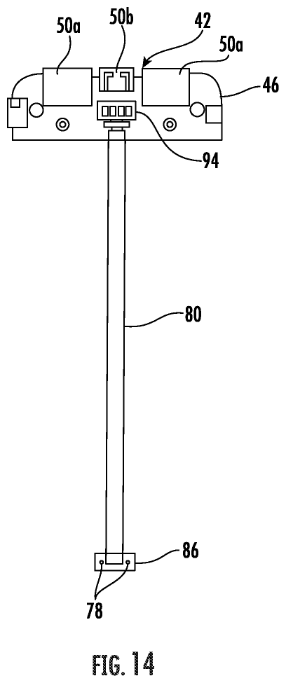

A contact support board 86 may support the at least one charging contact 78, and in this example, two charging contacts. The lead 80 is connected to the contact support board 86 and extends from the contact support board to the circuit board 46 as shown in the schematic plan view in FIG. 14 of the circuit board and the lead that connects to the contact support board. The contact support board 86 may be formed as a circuit board having circuit traces that connect the lead 80 and charging contacts 78 supported by the contact support board. In the example of FIG. 9, the electronic cigarette 72 is inserted completely within the channel 70 and the battery contacts on the end of the electronic cigarette that is inserted within the channel 70 engage the charging contacts 78 mounted on the contact support board 86 within the channel for charging the electronic cigarette. An electronic cigarette power module 87 may be mounted on the top surface of the circuit board 46 and provide power to the electronic cigarette and also connect to the charging circuit and IC 43 (FIG. 12).

A USB cable 88 is connected at one end to one of the Type A USB connector ports 50a and connected at the other end to a portable phone 90, such as an iPhone, allowing simultaneous charging of the portable phone and electronic cigarette 72. Other devices not shown may be charged as long as the devices accept a USB connector cable end for charging and have one end of the USB cable connected to the device to be charged, and the other end connected to the Type A USB connector port 50a or the Type C USB connector port 50b on the charging device 20.

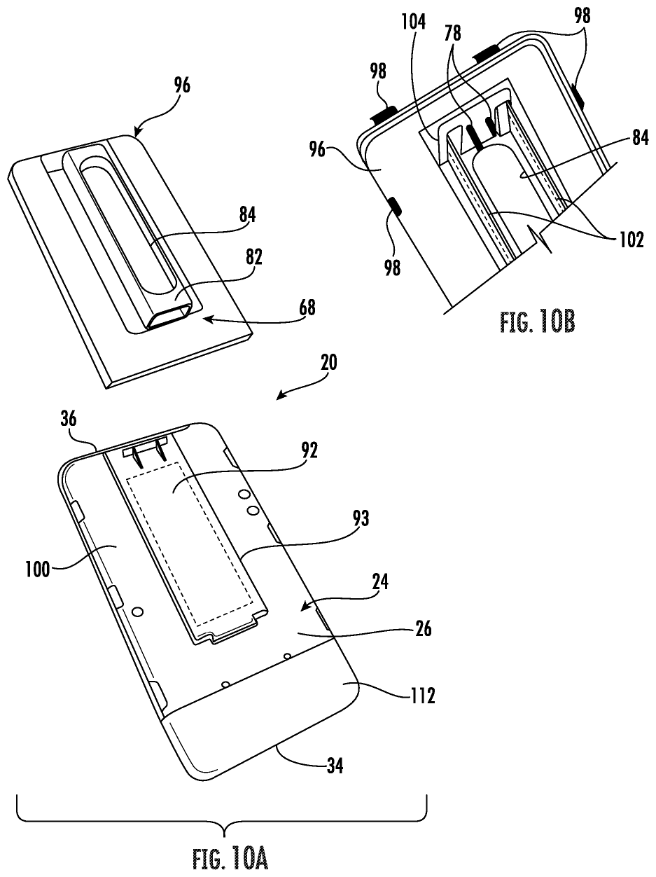

A magnet 92 is positioned at the top 26 of the portable housing 24 under the channel 70 to aid in retaining the electronic cigarette 72 in the charging position 74 as shown by the dashed line for the magnet in FIG. 1. The magnet 92 may be a thin, elongate magnet and positioned within a slight rectangular configured cavity 94 (FIG. 10A) formed at a top cover 100 that is visible when the retainer cover 96 is removed, as explained in detail below relative to FIGS. 10A and 10B. The cavity 94 may be about 3 inches long, 1 inch wide, and 1/16 inch in height so that the magnet 92 can be inserted and retained therein by an adhesive or other securement mechanism and not interfere with the battery 40. At least one LED 94 is mounted on the circuit board 46 and operatively connected to the LED driver circuit 56 in the integrated circuit 43 to indicate a remaining charge on the battery 50. The charging circuit 20 could be modified so that the LED's include a charging status of an electronic cigarette 72 or USE charged device such as the phone 90 during charging. It may also be used to indicate an on/off status of the charging device 20 when the on/off switch 60 is depressed on or off. When the charging device 20 is on, for example, the LED's will light with the number of lit LED's indicating how much power remains in the battery 40.

The portable housing 24 is substantially rectangular configured and sized to be carried by hand and can be formed of a plastic material or other similar materials, including a lightweight metallic material. Plastic may be easily injection molded and pieces assembled to produce the portable housing and other components at high production speeds. The sides 30,32 and front and rear end 34,36 form the housing periphery, which may be formed as one piece. The top 26 may be formed integral with the periphery or be a separate piece that is snapped into place. In this example, the bottom 28 of the portable housing 24 can be formed as a separate piece as a bottom cover 95 that can be removed and snap fit onto the sides 30,32 and the front end 34 and rear end 36.

FIG. 11 illustrates the interior of the portable housing 24 where a bottom cover 95 forming the bottom 28 is removed and showing relative dimensions of the circuit board 46 relative to the battery 40. In this example, the portable housing 24 is about 2½ inches wide by about 5 inches long, and with the bottom cover 95, about ½ inch in height. The circuit board 46 is contained within the front end 34 of the portable housing and extends across most of the width and is about 2⅜ inches long (across the width of the portable housing) and about ¾ of an inch wide (from front to back). The battery 40 extends substantially along the remainder of length of the portable housing 24 and is about 3¾ inches long in this example, and about 2¼ inches wide. In one example, the battery 40 is a 3.7 volt rechargeable, lithium-ion battery and about 37 watt hours (wh), and in a measured example, about 38.48 wh, and 10,000 milliamp hours (mAh) and has two leads as negative (N) and positive (P) leads connected into the circuit board 46 (FIGS. 1 and 11). Traces 96 formed on both sides of the circuit board 46 provide electrical contact between various components, such as to the integrated circuit 43 (FIGS. 1, 11 and 12).

The top side of the circuit board 46 facing towards the top 26 of the portable housing 24 is shown in FIG. 12, where the circuit board is shown lifted up 90 degrees to show the various components, such as the two Type A USB connector ports 50a mounted on the circuit board, and the Type C USB connector port 50b mounted on the circuit board between the first and second Type A USB connector ports. Circuit board mounts 97 may support the circuit board 46 relative to the portable housing 24. The openings 52 formed for the respective USB connector ports 50 are shown in detail in FIG. 12.

The circuit board 46 also includes the micro USB charging port 64 mounted thereon that permits charging of the battery 40 by connection to a power source via a micro USB cable. This micro USB charging port 64 may be used for other purposes and is mounted on the circuit board 46 so that it may be accessed through an opening in the left side 30 of the portable housing 24, which opening is configured to receive a cable connector that fits into the micro USB charging port 64. The push button on-off switch 60 is mounted on the circuit board 46 and connected to the charging circuit 42 and accessible from an opening in the right side 32 of the portable housing 24. Pressing the on-off switch 60 may activate the charging circuit 42 and power the LED's 94 that are mounted on the circuit board 46. In this example, four LED's 94 are connected to the charging circuit and mounted on the circuit board 46 (FIGS. 12 and 14).

As best shown in FIGS. 10A and 10B, the top 26 of the portable housing 24 includes a snap fit, cigarette retainer cover 96 that includes at its central portion the channel member 69 formed, in an example, as a plastic injection molded piece that snap fits via tabs 98 into a top cover 100 forming the top 26 of the portable housing 24. The retainer cover 96 covers a substantial portion of the top cover 100 and has the channel member 69 formed therein and extending longitudinally along the retainer cover 96. The channel member 69 includes the channel 70 that is substantially rectangular configured and forms the channel by parallel, internal walls 102 as shown in the underside view of the retainer cover 96 in FIG. 10B. When the retainer cover 96 is snapped on top of the top cover 100, the electronic cigarette 72 may be received therein by sliding it over the top cover 100 and into the channel 70, which retains the electronic cigarette in the charging position 34 with the help of the magnet 92. The lead 80 extends from the circuit board 46 (FIG. 12) along the length of the portable housing 24 on top of the battery 40 when viewed from the top 26 and extends upward at the rear end 36 of the portable housing and connects onto the contact support board 86 supporting the two charging contacts 78. The contact support board 86 is vertically positioned and received within a board receiving slot 104 within the retainer cover 96 as shown in the underside view of the retainer cover in FIG. 10B, which may include a metallic contact.

The underside of the top cover 100 of the portable housing 24 at the circuit board 46 area includes a light channel block 106 having four slots 108 (FIG. 12) that receive four parallel light channel members 110 (FIG. 13) that extend from a front end, top plate 112 that is received at the front end 34 of the portable housing 24 over the top cover 100, as shown in FIG. 10A. The light channel members 110 extend through slots cut into the top cover 100 and through the slots 108 within the light channel block 106 and terminate near the LED's 94 positioned on the circuit board 46. When the LED's are activated, light passes through the light channel members and can be seen at their termination at the front end top cover plate 82, and thus, indicate whether the LED's are on or off. For example, if the battery 40 is only 25% charged, the charging circuit 42 will activate one LED 94, indicating that because one out of four LED's is activated and lit, there is a 25% charge of the battery 40. When the battery 40 becomes 50% charged, a second LED 94 will light, indicating a 50% charge. When all four LED's are activated, it indicates a 100% charge of the battery 40.

An example block diagram of the integrated circuit 43 for the charging circuit 42 is shown in FIG. 15, and as noted before, includes the system control 54, LED driver circuit 56, and at least one USB circuit 58. In this example, the USB circuit 58 includes the two Type A connector ports 50a connected to the USB circuit 58 and a Type C connector port 50b connected to the USB circuit 58. The system control 54 is configured to control different components and circuits, including the LED driver circuit 56, USB circuit 58, and other circuits, such as a boost/charger driver circuit 114, bandgap circuit 116, a key circuit 118, and other circuits that operate with the system control 54.

An example integrated circuit 43 that may be used with the charging device is a IP5310 IC that corresponds to a 3 amp charging and 3.1 amp discharge integrated Type-C protocol mobile power silicon-on-chip (SOC) circuit that operates also as an integrated boost converter and lithium battery charging circuit as part of boost/charger driver circuit. It may include a DC-DC converter that works, for example, at 500 KHz and provides 3.1 amp output, and a switch charging technology to provide up to 3 amps current. It may support an I2C interface and can be packaged in a 5×5 millimeter package, adopting the QFN32 5×5 millimeter package configuration. The charging device 20 supports the USB-C, 3 amp fast charge via the USB Type C connector port 50b and may charge a battery such as in a conventional JUUL device up to 50 times and charge two USB stored devices, such as an iPhone and iPad, at once with the LED display showing the remaining charge. The micro USB charging port 64 may be used for recharging the battery 40. The input of the Type C USB connector 50b is DC 5 volts/3 amps and the micro port 64 is DC 5 amps/2 amps input. The output may be about 5 volts DC and 3 amps with a 10,000 mAh capacity, and in one measurement, 38.48 watt hours (wh). The USB-C connector is an interface type that may support greater speeds, including 40 GBPS with higher wattage. The charging circuit 42 may be configured to convert input voltage and current output to specified sizes and capacities of different devices.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A charging device for an electronic cigarette and USB charged devices, comprising:
a portable housing having a top, a bottom, sides and a front end and a rear end;
a battery carried within the housing;
a charging circuit connected to the battery;
at least one USB connector port carried within the portable housing and connected to the charging circuit and configured for charging a USB charged device when connected thereto;
a cigarette retainer at the top of the portable housing and configured to receive and retain an electronic cigarette in a charging position; and
at least one charging contact connected to the charging circuit and positioned at the cigarette retainer and configured to engage a battery contact on the electronic cigarette when in the charging position to charge the electronic cigarette.

2. The charging device of claim 1 wherein said cigarette retainer comprises a channel member extending longitudinally along the top to the rear end of the portable housing and configured as a channel that receives the electronic cigarette therein, and said at least one charging contact is positioned within the channel adjacent the rear end of the housing.

3. The charging device of claim 2 wherein said channel member comprises an upper surface and a slot formed in the upper surface and configured to expose for view an electronic cigarette received within the channel.

4. The charging device of claim 2 wherein said channel is substantially rectangular configured to retain a rectangular configured electronic cigarette therein.

5. The charging device of claim 1 comprising a magnet at the cigarette retainer to aid in retaining the electronic cigarette in the charging position.

6. The charging device of claim 1 comprising a contact support board supporting the at least one battery contact and a lead connected to the contact support board and operatively connected to the charging circuit.

7. The charging device of claim 1 comprising a circuit board supported within the front end of the portable housing and connected to said battery, wherein said charging circuit and at least one USB connector port are mounted on said circuit board.

8. The charging device of claim 1 wherein said charging circuit comprises an integrated circuit comprising a system control, Light Emitting Diode (LED) driver circuit, and at least one USB circuit connected to the at least one USB connector port.

9. The charging device of claim 1 comprising at least one LED connected to the charging circuit to indicate a charging status of the battery.

10. The charging device of claim 9 comprising at least one light channel member extending from the at least one LED to the top surface of the portable housing.

11. The charging device of claim 1 wherein said at least one USB connector port comprises spaced first and second Type A connector ports, and a Type C connector port positioned between the first and second Type A connector ports.

12. The charging device of claim 1 wherein the portable housing has at least one opening configured to receive a respective USB connector that connects to the respective USB connector port.

13. The charging device of claim 1 wherein said portable housing is rectangular configured and sized to be carried by hand.

14. A charging device for an electronic cigarette and USB charged devices, comprising:
a portable housing having a top, a bottom, sides and a front end and rear end;
a battery carried within the housing;
a circuit board mounted within the front end of the portable housing and connected to said battery;
a charging circuit mounted on the circuit board;
first and second Type A USB connector ports mounted on the circuit board in spaced relation to each other, and a Type C USB connector port mounted on the circuit board between the first and second Type A USB connector ports, each of the USB connector ports connected to the charging circuit and configured for charging USB charged devices when connected thereto;
a cigarette retainer comprising a channel member extending longitudinally along the top of the portable housing to the rear end of the portable housing and configured as a channel that receives the electronic cigarette therein and retains the electronic cigarette in a charging position; and
at least one charging contact connected to the charging circuit and positioned within the channel at the rear end of the portable housing, and configured to engage a battery contact on the electronic cigarette when in the charging position to charge the electronic cigarette.

15. The charging device of claim 14 wherein said channel member comprises an upper surface and a slot formed in the upper surface configured to expose for view an electronic cigarette received within the channel.

16. The charging device of claim 14 wherein said channel is substantially rectangular configured to retain an elongate and rectangular configured electronic cigarette therein.

17. The charging device of claim 14 comprising a magnet positioned at the channel to aid in retaining the electronic cigarette in the charging position.

18. The charging device of claim 14 comprising a contact support board supporting the at least one battery contact and a lead connected to the contact support board and operatively connected to the circuit board.

19. The charging device of claim 14 wherein said charging circuit comprises an integrated circuit mounted on the circuit board and comprising a system control, Light Emitting Diode (LED) driver circuit, and at least one USB circuit.

20. The charging device of claim 14 comprising at least one LED mounted on the circuit board and connected to the charging circuit to indicate a charging status of the battery.

21. The charging device of claim 20 further comprising a light channel member extending from the at least one LED to the top of the portable housing.

22. The charging device of claim 14 wherein said portable housing is rectangular configured and sized to be carried by hand.

23. The charging device of claim 1 wherein the front end of the portable housing has openings at the respective USB connector ports and each configured to receive a USB connector that connects to a respective first and second Type A USB and Type C USB connector port.
